(19) United States
(12) Patent Application Publication
(10) Pub. No.: US 2011/0076609 A1
(43) Pub. Date: Mar. 31, 2011

(54) TONER CONTAINING BINDER RESIN HAVING WAX PROPERTIES AND METHOD OF PREPARING THE TONER

(75) Inventors: Dae Il Hwang, Daejeon-City (KR); Il Sun Hwang, Daejeon-City (KR); Duck Kyun Ahn, Daejeon-City (KR); Woo Young Yang, Daejeon-City (KR)

(73) Assignee: Samsung Fine Chemicals Co., Ltd.

(21) Appl. No.: 12/993,470

(22) PCT Filed: May 19, 2009
(86) PCT No.: PCT/KR09/02641

§ 371 Date: Nov. 18, 2010

(30) Foreign Application Priority Data
May 19, 2008 (KR) 10-2008-0046288

(51) Int. Cl. G03G 9/087

(52) U.S. Cl. 430/109.4; 430/137.22

(57) ABSTRACT

Provided are a toner containing a resin having wax properties and a method of preparing the toner. The toner includes a binder resin into which at least one residue of the group consisting of a C8-C60 higher fatty acid residue and a C8-C60 higher alcohol residue is introduced by esterification, a colorant, and at least one additive.

### CROSS-REFERENCE TO RELATED PATENT APPLICATION

This application is a national phase of International Application No. PCT/KR2009/002641, entitled “TONER CONTAINING BINDER RESIN HAVING WAX PROPERTIES AND METHOD OF PREPARING THE TONER”, which was filed on May 19, 2009, and which claims priority to Korean Patent Application No. 10-2008-0046288, filed on May 19, 2008, in the Korean Intellectual Property Office, the disclosure of which is incorporated herein in its entirety by reference.

### BACKGROUND OF THE INVENTION

1. Technical Field

The present invention relates to a toner and a method of preparing the same, and more particularly, to a toner containing a binder resin having wax properties and a method of preparing the toner.

2. Background Art

Recently, the need for a toner capable of ensuring fixability at low temperature and storage stability at high temperature has increased in the printing industry.

In general, a toner is prepared by adding a colorant, a charge control agent, and/or wax to a thermoplastic resin acting as a binder resin. In addition, inorganic fine metal particles such as silica or a titanium oxide may be added to the toner as external additives in order to provide the toner with fluidity or improve its physical properties such as charge controlling properties or cleaning properties.

A method of preparing a toner generally includes preparing a wax-resin dispersion.

The wax-resin dispersion may be prepared by wax emulsification.

A method of preparing a wax emulsion using a homo mixer or a high-pressure homogenizer is disclosed in Japanese Patent Publication No. 2002-308994. According to the method, wax is emulsified at a high pressure of 500 to 1,000 kg/cm², thereby increasing manufacturing costs.

A wax-resin dispersion may be prepared by dissolving wax and a resin in an organic solvent, and dispersing the mixture in a polar solvent such as water. In such a wax-resin dispersion, the resin surrounds the surface of the wax, and thus the stability and durability of the wax are improved. However, if the content of the wax exceeds a certain level, the wax leaks out of the resin.

Wax-resin dispersions may be applied in various fields. However, excessive energy is required to prepare a wax-resin dispersion.

### DETAILED DESCRIPTION OF THE INVENTION

### Technical Problem

The present invention provides a toner having wax properties without externally adding wax to the toner and a method of preparing the toner.

The present invention provides an inexpensively prepared toner and a method of preparing the same.

### Technical Solution

According to an aspect of the present invention, there is provided a toner including:
a binder resin into which at least one residue selected from the group consisting of a C8-C60 higher fatty acid residue and a C8-C60 higher alcohol residue is introduced by esterification;
a colorant; and
at least one additive.

According to another aspect of the present invention, there is provided a method of preparing a toner, the method including the steps of :
preparing a dispersion medium;
preparing a toner suspension by adding a binder resin into which at least one residue selected from the group consisting of a C8-C60 higher fatty acid residue and a C8-C60 higher alcohol residue is introduced by esterification, a colorant, and at least one additive to the dispersion medium; and
preparing a toner mixture by removing an organic solvent from the toner suspension.

The binder resin may be prepared by introducing at least one residue selected from the group consisting of the higher fatty acid residue and the higher alcohol residue into a polyester resin by esterification.

The polyester resin may be prepared by the polycondensation of an acid component and a diol component.

The total content of the higher fatty acid residue and the higher alcohol residue may be in the range of 1 to 50% by weight based on the total weight of the binder resin into which at least one residue selected from the group consisting of the higher fatty acid residue and the higher alcohol residue is introduced.

The colorant may be in the form of a pigment master batch.

The pigment master batch may include a resin into which at least one residue selected from the group consisting of a C8-C60 higher fatty acid residue and a C8-C60 higher alcohol residue is introduced by esterification, and a pigment dispersed in the resin.

### BEST MODE FOR CARRYING OUT THE INVENTION

Hereinafter, a toner and a method of preparing the toner according to the present invention will be described in more detail with reference to exemplary embodiments of the invention.

A toner according to an embodiment of the present invention includes: a binder resin into which at least one residue selected from the group consisting of a C8-C60 higher fatty acid residue, for example, a C10-C55 or a C12-C50 higher fatty acid residue and a C8-C60 higher alcohol residue, for example, a C10-C55 or a C12-C50 higher alcohol residue is introduced by esterification; a colorant; and at least one additive.

The binder resin may include a polyester resin.

The polyester resin may be prepared by the polycondensation of a diacid component and a diol component.

The diacid component may be aromatic dicarboxylic acid such as terephthalic acid or isophthalic acid; aliphatic dicarboxylic acid such as phthalic acid, sebacic acid, maleic acid, fumaric acid, or adipic acid; and lower alkyl ester or acid anhydride thereof. The lower alkyl ester may be monomethyl ester, ethyl ester, dimethyl ester, diethyl ester, or the like. The aromatic dicarboxylic acid increases the glass transition temperature (Tg) and strength of the polyester resin, improves blocking resistance of the toner, and improves water resistance due to its hydrophobicity.

The diol component may be an aliphatic diol component and/or an aromatic diol component. The aliphatic diol component may be ethylene glycol, neopentyl glycol, propylene glycol, butanediol, polyethylene glycol, 1,2-propane diol, 1,4-butanediol, diethylene glycol, triethylene glycol, 1,4-cyclohexane dimethanol, and/or hydrogenated bisphenol A. The aromatic diol component may be: a bisphenol A derivative including ethylene oxide such as polyoxyethylene-(2.0)-2,2-bis(4-hydroxyphenyl)propane, polyoxyethylene-(2.3)-2,2-bis(4-hydroxyphenyl)propane, polyoxyethylene-(2.8)-2,2-bis(4-hydroxyphenyl)propane, and polyoxyethylene-(3.0)-2,2-bis(4-hydroxyphenyl)propane; and a bisphenol A derivative including propylene oxide such as polyoxypropylene-(2.0)-2,2-bis(4-hydroxyphenyl)propane, polyoxypropylene-(2.3)-2,2-bis(4-hydroxyphenyl)propane, polyoxypropylene-(2.8)-2,2-bis(4-hydroxyphenyl)propane, and polyoxypropylene-(3.0)-2,2-bis(4-hydroxyphenyl)propane.

The aliphatic diol component is used to increase the polycondensation rate of the binder resin and the content of the aliphatic diol component may be selected without limitation. The aromatic diol component increases the glass transition temperature (Tg) and strength of the polyester resin, reduces the amount of the lower molecular weight residue of the polyester resin, improves blocking resistance of the toner, and controls reactivity of the polyester resin, and the content of the aromatic diol component may be selected without limitation.

In addition, a polyhydric carboxylic acid component containing an at least trihydric carboxylic acid, and/or a polyhydric alcohol component containing an at least trihydric alcohol may be used to prepare the polyester resin. The polyhydric carboxylic acid and/or the polyhydric alcohol residue may increase strength of the polyester resin, control molecular weight of the polyester resin or molecular weight distribution thereof, and improve properties of the toner, e.g., fixing properties of the toner.

The polyhydric carboxylic acid may be trimellitic acid, pyromellitic acid, 1,2,4-cyclohexane tricarboxylic acid, 2,5,7-naphthalene tricarboxylic acid, 1,2,4-naphthalene tricarboxylic acid, 1,2,5-hexane tricarboxylic acid, 1,2,7,8-octane tetracarboxylic acid, or an acid anhydride thereof.

The polyhydric alcohol may be sorbitol, 1,2,3,6-hexanetetraol, 1,4-sorbitan, pentaerythritol, dipentaerythritol, tripentaerythritol, 1,2,4-butanetriol, 1,2,5-pentatriol, glycerol, 2-methylpropanetriol, 2-methyl-1,2,4-butanetriol, trimethylolethane, trimethylolpropane, 1,3,5-trihydroxymethylbenzene, or the like. For example, trimellitic acid or an anhydride thereof, pentaerythritol, trimethylolpropane may be used as the polyhydric alcohol.

The polyhydric carboxylic acid component and/or the polyhydric alcohol component may be used alone or in combination of at least two or more and the contents thereof may be selected without limitation.

A monomer which does not deteriorate properties of the polyester resin may also be used.

An acid value of the binder resin according to an embodiment of the present invention may be in the range of 3 to 100 mgKOH/g. If the acid value is less than 3 mgKOH/g, the following toner suspension may not be easily prepared. On the other hand, if the acid value is greater than 100 mgKOH/g, the toner fabricated using the toner suspension may have low environmental stability, thereby deteriorating blocking resistance, water resistance, adhesion, and the like. The acid value may be in the range of 5 to 80 mgKOH/g.

The higher fatty acid may be caprylic acid, capric acid, undecanoic acid, lauric acid, tridecanoic acid, myristic acid, pentadecanoic acid, palmitic acid, palmitoleic acid, heptadecanoic acid, stearic acid, oleic acid, ricinoleic acid, linoleic acid, arachidic acid, arachidonic acid, tricosanoic acid, erucic acid, behenic acid, lignoceric acid, nervonic acid, or the like.

The higher alcohol may be isostearyl alcohol, stearyl alcohol, cetyl alcohol, lauryl alcohol, or the like.

Higher fatty acid residue and higher alcohol residue each having less than 8 carbon atoms may decrease durability of the binder resin, thereby reducing storage stability of the binder resin, even if a higher fatty acid residue and a higher alcohol residue each having less than 8 carbon atoms are introduced into the binder resin by esterification. Therefore, the binder resin having a higher fatty acid residue and a higher alcohol residue each having less than 8 carbon atoms may not function as wax. On the other hand, a higher fatty acid residue and a higher alcohol residue each having greater than 60 carbon atoms are not easily introduced into the binder resin by esterification. Even if a higher fatty acid residue and a higher alcohol residue each having greater than 60 carbon atoms are introduced into the binder resin, the particle size of the binder resin when being dispersed in the following dispersion medium increases, and the particle size distribution of the binder resin may deteriorate. The amount of the higher fatty acid residue and the higher alcohol residue may be in the range of 1 to 50% by weight based on the total weight of the binder resin into which at least one residue selected from the group consisting of the higher fatty acid residue and the higher alcohol residue is introduced. If the content of the higher fatty acid residue and the higher alcohol residue is less than 1% by weight based on the total weight of the binder resin, the dispersed particles of the binder resin may not sufficiently function as wax. On the other hand, if the amount of the higher fatty acid residue and the higher alcohol residue is greater than 50% by weight based on the total weight of the binder resin, the melting point of the binder resin may decrease so that durability of the binder resin is decreased, the particle size of the binder resin dispersed in the following dispersion medium may increase, and the particle size distribution of the binder resin may deteriorate.

The colorant may be used in the form of a pigment itself, or alternatively, in the form of a pigment master batch in which the pigment is dispersed in a resin. By using a pigment master batch, the charging properties of the toner particles may be improved by suppressing the surface exposure of the colorant.

A resin used in the pigment master batch may be a resin into which at least one of the C8-C60 higher fatty acid residue and the C8-C60 higher alcohol residue is introduced by esterification, or another known resin. If the binder resin includes the higher fatty acid residue, a resin including the higher fatty acid residue may be used for the pigment master batch. In addition, if the binder resin includes the higher alcohol residue, a resin including the higher alcohol residue may be used for the pigment master batch. Furthermore, if the binder resin includes both of the higher fatty acid residue and the higher alcohol residue, a resin including both of the higher fatty acid residue and the higher alcohol residue may be used for the pigment master batch. The pigment master batch is a resin composition in which a pigment is uniformly dispersed. The pigment master batch is prepared by blending a pigment and a resin at high temperature and high pressure, or by dissolving a resin in a solvent to make a solution, adding a pigment to the solution and applying a high shearing force to the pigment containing solution in order to disperse the pigment. In the pigment master batch used in an embodiment of the present invention, the content of the pigment may be in the range of 10 to 70 parts by weight, preferably 20 to 50 parts by weight, based on 100 parts by weight of the pigment master batch. If the content of the pigment is less than 10 parts by weight based on 100 parts by weight of the pigment master batch, a desired color may not be reproduced because the content of the pigment in the toner is too low. On the other hand, if the content of the pigment is greater than 70 parts by weight based on 100 parts by weight of the pigment master batch, the pigment may not be uniformly dispersed in the pigment master batch.

The pigment may be selected from pigments commonly and commercially used, such as a black pigment, a cyan pigment, a magenta pigment, a yellow pigment and a mixture thereof.

Examples of the pigments are described below. A titanium oxide or carbon black may be used as the black pigment. A copper phthalocyanine compound and derivatives thereof, an anthraquine compound or a base dye lake compound may be used as the cyan pigment. In particular, a C.I. pigment blue 1, 7, 15, 15:1, 15:2, 15:3, 15:4, 60, 62, 66, or the like may be used. A condensed nitrogen compound, an anthraquine compound, a quinacridone compound, a base dye lake compound, a naphthol compound, a benzo imidazole compound, a thioindigo compound, or a perylene compound may be used as the magenta pigment. In particular, a C.I. pigment red 2, 3, 5, 6, 7, 23, 48:2, 48:3, 48:4, 57:1, 81:1, 144, 146, 166, 169, 177, 184, 185, 202, 206, 220, 221, 254, or the like may be used. A condensed nitrogen compound, an isoindolinone compound, an anthraquine compound, an azo metal complex, or an allyl imide compound may be used as the yellow pigment. In particular, a C.I. pigment yellow 12, 13, 14, 17, 62, 74, 83, 93, 94, 95, 109, 110, 111, 128, 129, 147, 168, or the like may be used.

The content of the colorant may be sufficient to color the toner and form a visible image by development, and preferably may be in the range of 3 to 15 parts by weight based on 100 parts by weight of the resin. When the amount of the colorant is less than 3 parts by weight based on 100 parts by weight of the resin, a coloring effect is not sufficient. On the other hand, when the amount of the colorant is greater than 15 parts by weight based on 100 parts by weight of the resin, a sufficient frictional charge amount may not be obtained due to low electrical resistance, thereby causing contamination.

Additionally, the additive may include a charge control agent, a neutralizer, a thickener, or a mixture thereof.

The charge control agent may be a negative charge control agent or a positive charge control agent. Examples of the negative charge control agent include an organic metal complex or a chelate compound such as an azo complex containing chromium or a mono azo metal complex; a salicylic acid compound containing metal such as chromium, iron and zinc; and an organic metal complex of an aromatic hydroxycarboxylic acid and an aromatic dicarboxylic acid, and any known negative charge control agent may be used without limitation. Examples of the positive charge control agent include nigrosine and products of nigrosine modified with a fatty acid metal salt; and an onium salt including a quaternary ammonium salt such as tributylbenzylammonium 1-hydroxy-4-naphthosulfonate and tetrabutylammonium tetrafluoroborate. These positive charge control agents may be used alone or in combination of two or more. Since the charge control agent stably and quickly charges a toner by its electrostatic force, the toner may be stably supported on a developing roller.

The amount of the charge control agent included in the toner may generally be in the range of 0.1 to 10 parts by weight based on 100 parts by weight of the toner composition. If the content of the charge control agent is less than 0.1 parts by weight based on 100 parts by weight of the toner composition, toner charging speed is too low and the charging amount is too low to function as a charge control agent. On the other hand, if the content of the charge control agent is greater than 10 parts by weight based on 100 parts by weight of the toner composition, overcharging may occur and this may distort a formed image.

If the binder resin includes an acid group, a base group used to neutralize the acid group, i.e., a neutralizer, may be used. The neutralizer may be a hydroxide of alkali metal such as potassium hydroxide, sodium hydroxide, or lithium hydroxide; a carbonate of alkali metal such as sodium carbonate, potassium carbonate, or lithium carbonate; an acetate of alkali metal; or alkanol amine such as ammonium hydroxide, methyl amine, dimethyl amine, trimethyl amine, triethyl amine, or triethanol amine. For example, a hydroxide of alkali metal may be used as the neutralizer.

The amount of the neutralizer may be in the range of 0.1 to 3.0 g/eq., for example, 0.5 to 2.0 g/eq. based on 1 g/eq. of the acid group.

The thickener may include at least one selected from the group consisting of polyvinyl pyrrolidone, polyvinyl alcohol, polyacrylic acid, gelatin, chitosan and sodium alginate, and preferably polyvinyl alcohol.

In addition, the additive may further include higher fatty acid, fatty acid amide, metal salts thereof, or the like. The higher fatty acid, the fatty acid amid, and the metal salts thereof may be used in order to prevent deterioration of developing properties and to obtain high quality images.

The toner may further include external additives. The external additives may be used to improve fluidity of the toner or control charging properties, and examples of the external additives are large particulate silica, small particulate silica and polymer beads.

Hereinafter, a method of preparing a toner including a polyester resin constituting a binder resin into which a higher fatty acid residue and/or a higher alcohol residue are introduced, will be described in more detail.

### Preparation of Polyester Resin Including Higher Fatty Acid Residue And/Or Higher Alcohol Residue

The acid component and the diol component described above are added to a reactor, and a catalyst such as dibutyl tin oxide is added thereto. Then, the reactor is heated to a predetermined temperature while stirring, and the polycondensation is performed to produce a polyester resin. Byproducts produced during the polycondensation are removed using distillation under a reduced pressure. Then, the higher fatty acid component and/or the higher alcohol component described above are further added to the reactor. The reactor is heated while stirring to perform esterification between the polyester resin and the higher fatty acid component, and/or between the polyester resin and the higher alcohol component, thereby obtaining a binder resin into which the higher fatty acid and/or the higher alcohol residues are introduced. However, the present invention is not limited thereto, and the acid component, the diol component, the higher fatty acid component and/or the higher alcohol component may be simultaneously added to the reactor to perform esterification and polycondensation, thereby preparing a binder resin having wax properties.

The binder resin including the higher fatty acid residue and/or the higher alcohol residue includes ester bonds formed by the reaction between a hydroxyl group of the polyester resin and an acid group of the fatty acid/alcohol. Due to the ester bonds, wax properties are expressed, and thus the binder resin may function as wax. Thus, an additional wax is not necessary in order to prepare a toner suspension. In addition, since the ester bonds are formed within the binder resin, decrease of blocking resistance and durability of the binder resin, which may be caused when wax is exposed on the surface of the conventional binder resin prepared by adding a large amount of wax to the polyester resin, may be prevented.

### Preparation of Dispersion Medium

A polar solvent, a surfactant, and selectively an organic solvent, a neutralizer, and/or a thickener are added to a reactor, and the mixture is stirred to prepare a dispersion medium. The organic solvent may be added to the reactor after solids such as the neutralizer are completely dissolved in the polar solvent. During the preparation of the dispersion medium, temperature, pressure, and stirring speed are not limited.

The polar solvent may include at least one selected from the group consisting of water, glycerol, ethanol, ethylene glycol, propylene glycol, diethylene glycol, dipropylene glycol, and sorbitol, and may preferably be water.

The surfactant may include at least one selected from the group consisting of a nonionic surfactant, an anionic surfactant, a cationic surfactant, and an amphoteric surfactant.

Examples of the nonionic surfactant include polyvinyl alcohol, polyacrylic acid, methylcellulose, ethylcellulose, propylcellulose, hydroxyethylcellulose, carboxymethylcellulose, polyoxyethylene cetyl ether, polyoxyethylene lauryl ether, polyoxyethylene octylphenyl ether, polyoxyethylene stearyl ether, polyoxyethylene norylphenyl ether, ethoxylate, phosphate norylphenols, triton, and dialkylphenoxypoly(ethyleneoxy)ethanol. Examples of the anionic surfactant include sodium dodecyl sulfate, sodium dodecyl benezene sulfonate, sodium dodecyl naphthalene sulfate, dialkyl benzenealkyl sulfate, and sulfonate. Examples of the cationic surfactant include alkyl benzene dimethyl ammonium chloride, alkyl trimethyl ammonium chloride, and distearyl ammonium chloride. Examples of the amphoteric surfactant include amino acid-type amphoteric surfactant, betaine amphoteric surfactant, lecitin, and taurin.

The surfactants described above may be used alone or in combination of two or more.

The organic solvent used herein is volatile, has a lower boiling point than the polar solvent, and is not miscible with the polar solvent. The organic solvent may include at least one selected from the group consisting of esters such as methyl acetate or ethyl acetate; ketones such as acetone or methylethyl ketone; hydrocarbons such as dichloromethane or trichloroethane; and aromatic hydrocarbons such as benzene.

### Preparation of Toner Particles Including Binder Resin Into Which Higher Fatty Acid Residue And/Or Higher Alcohol Residue Are Introduced

The binder resin into which the higher fatty acid residue and/or the higher alcohol residue are introduced, a colorant, and a charge control agent are sequentially added to the reactor filled with the dispersion medium. The resultant is mixed in a refluxing state under appropriate mixing conditions of stirring speed, temperature, and time, to prepare a toner suspension. If the binder resin into which the higher fatty acid residue and/or the higher alcohol residue are introduced is used, a toner suspension including a resin having wax properties, a volume average particle size ranging from 4 to 20 μm, and a 80% span value of 0.9 or less, may be prepared without using a high-pressure homogenizer. Thus, the costs for manufacturing the toner suspension may be significantly reduced.

Then, a toner mixture is prepared by removing the organic solvent from the toner suspension, and the reactor containing the toner mixture is cooled to room temperature.

Then, toner particles are separated from the toner mixture using a filter and washed to remove impurities such as the surfactant.

The washed toner particles are dried.

The stirring speed, stirring time, reaction temperature, reaction time, conditions for removing the organic solvent, etc., may vary according to types of the reactant such as acid, diol, fatty acid, and higher alcohol, and types of the solvent.

Hereinafter, the present invention will be described more specifically with reference to the following examples. The following examples are for illustrative purposes only and are not intended to limit the scope of the invention.

### EXAMPLE

### Preparation of Binder Resin

### Preparation Example 1

### Preparation of Polyester Resin 1 Having Higher Fatty Acid Residue

A 3 L reactor equipped with a stirrer, a thermometer, and a condenser was installed in an oil bath containing a heating medium. Monomers, i.e., 50 g of dimethyl terephthalate, 47 g of dimethyl isophthalate, 80 g of 1,2-propylene glycol, and 3 g of trimellitic acid were added to the reactor. 0.09 g (i.e., an amount of 500 ppm with respect to the total weight of the monomers) of dibutyl tin oxide was added thereto as a catalyst. Then, the reactor was heated to 150° C. while stirring the mixture at a speed of 150 rpm. The reaction was performed for about 6 hours, and then the reactor was heated to 220° C. The reaction pressure was decreased to 0.1 ton in order to remove byproducts, and then the reaction was performed for 15 hours. 20 g of stearic acid was added thereto, and the resultant was stirred at 220° C. for 2 hours to perform esterification to obtain a polyester resin 1 into which higher fatty acid(stearic acid) residue is introduced.

The glass transition temperature (Tg) of the polyester resin 1 measured using a differential scanning calorimeter (DSC) was 51° C. Also, the number average molecular weight and PDI of the polyester resin 1 measured using a gel permeation chromatography (GPC) using polystyrene as a standard sample were respectively 4,200 and 3.5. The acid value of the polyester resin 1 measured by titration was 14 mgKOH/g.

### Preparation Example 2

### Preparation of Polyester Resin 2 Having Higher Fatty Acid Residue

A polyester resin 2 into which higher fatty acid residue is introduced was prepared in the same manner as in Preparation Example 1, except that 120 g of stearic acid was used instead of 20 g of stearic acid.

The Tg of the polyester resin 2 was 42° C., the number average molecular weight of the polyester resin 2 was 4,100, and the PDI of the polyester resin 2 was 3.8. The acid value of the polyester resin 2 was 19 mgKOH/g.

### Preparation Example 3

### Preparation of Polyester Resin 3 Having Higher Alcohol Residue

A polyester resin 3 into which higher alcohol(stearyl alcohol) residue is introduced was prepared in the same manner as in Preparation Example 1, except that stearyl alcohol was used instead of stearic acid.

The Tg of the polyester resin 3 was 41° C., the number average molecular weight of the polyester resin 3 was 4,000, and the PDI of the polyester resin 3 was 3.7. The acid value of the polyester resin 3 was 10 mgKOH/g.

### Preparation Example 4

### Preparation of Polyester Resin 4 Having Higher Fatty Acid And Higher Alcohol Residues

A polyester resin 4 into which higher fatty acid and higher alcohol residues are introduced was prepared in the same manner as in Preparation Example 1, except that 10 g of stearic acid and 10 g of stearyl alcohol were used instead of 20 g of stearic acid.

The Tg of the polyester resin 4 was 44° C., the number average molecular weight of the polyester resin 4 was 4,200, and the PDI of the polyester resin 4 was 3.5. The acid value of the polyester resin 4 was 12 mgKOH/g.

### Preparation Example 5

### Preparation of Polyester Resin 5 Without Higher Fatty Acid And Higher Alcohol Residues

A polyester resin 5 was prepared in the same manner as in Preparation Example 1, except that stearic acid was not used.

The Tg of the polyester resin 5 was 60° C., the number average molecular weight of the polyester resin 5 was 4,100, and the PDI of the polyester resin 5 was 3.2. The acid value of the polyester resin 5 was 15 mgKOH/g.

### Preparation of Pigment Master Batch

### Preparation Example 6

### Preparation of Cyan Pigment Master Batch 1

The polyester resin 1, synthesized according to Preparation Example 1, was mixed with a blue pigment (C. I. pigment blue 15:3, color index(CI) No. 74160, manufactured by DIC, Japan) in a weight ratio of 6:4. Then, 50 parts by weight of ethyl acetate based on 100 parts by weight of the polyester resin 1 was added thereto, and the mixture was heated to about 60° C., and then stirred with a kneaded for 1 hour. Then, while the mixture was stirred at a speed of 50 rpm using a biaxial extruder having a vacuum device, ethyl acetate as a solvent was removed using the vacuum device to obtain a cyan pigment master batch 1.

### Preparation Example 7

### Preparation of Magenta Pigment Master Batch

A magenta pigment master batch was prepared in the same manner as in Preparation Example 6, except that the polyester resin 1 synthesized according to Preparation Example 1 was mixed with a magenta pigment (Red 122, manufactured by DIC, Japan) in a weight ratio of 6:4.

### Preparation Example 8

### Preparation of Yellow Pigment Master Batch

A yellow pigment master batch was prepared in the same manner as in Preparation Example 6, except that the polyester resin 1 synthesized according to Preparation Example 1 was mixed with a yellow pigment (manufactured by Clariant, Germany) in a weight ratio of 6:4.

### Preparation Example 9

### Preparation of Black Pigment Master Batch

A black pigment master batch was prepared in the same manner as in Preparation Example 6, except that the polyester resin 1 synthesized according to Preparation Example 1 was mixed with a carbon black pigment (CB 4, manufactured by Degussa GmbH, Germany) in a weight ratio of 6:4.

### Preparation Example 10

### Preparation of Cyan Pigment Master Batch 2

A cyan pigment master batch 2 was prepared in the same manner as in Preparation Example 6, except that the polyester resin 2 synthesized according to Preparation Example 2 was used instead of the polyester resin 1 synthesized according to Preparation Example 1.

### Preparation Example 11

### Preparation of Cyan Pigment Master Batch 3

A cyan pigment master batch 3 was prepared in the same manner as in Preparation Example 6, except that the polyester resin 3 synthesized according to Preparation Example 3 was used instead of the polyester resin 1 synthesized according to Preparation Example 1.

### Preparation Example 12

### Preparation of Cyan Pigment Master Batch 4

A cyan pigment master batch 4 was prepared in the same manner as in Preparation Example 6, except that the polyester resin 4 synthesized according to Preparation Example 4 was used instead of the polyester resin 1 synthesized according to Preparation Example 1.

### Preparation Example 13

### Preparation of Cyan Pigment Master Batch 5

A cyan pigment master batch 5 was prepared in the same manner as in Preparation Example 6, except that the polyester resin 5 synthesized according to Preparation Example 5 was used instead of the polyester resin 1 synthesized according to Preparation Example 1.

### Preparation of Toner Particles

### Example 1

400 g of distilled water, 10 g of polyvinyl alcohol (P-24, manufactured by DC Chemical Co. of Seoul, Korea), and 5 g of sodium dodecylsulfate (manufactured by Aldrich Chemical Company in Milwaukee, Wis.) as an anionic surfactant were added to a pressurizable 1 L reactor equipped with a condenser, a thermometer, and a impeller stirrer, and then solids were completely dissolved by heating the reactor and stirring at a rate of 500 rpm at 70° C. to obtain a dispersion medium. After the solids had completely dissolved in the dispersion medium, methyl ethyl ketone (manufactured by Aldrich Chemical Company in Milwaukee, Wisconsin) was added to the dispersion medium, thereby obtaining a milky white liquid composition.

Then, 60 g of the polyester resin 1, prepared according to Preparation Example 1, 40 g of the cyan pigment master batch 1 prepared according to Preparation Example 6, and 2 g of a charge control agent (N-23, HB Dinglong in Hubei, China) were sequentially added to the reactor. The resultant was mixed at a stirring speed of 1000 rpm at 75° C. for 5 hours.

Then, the stirring speed was decreased to 300 rpm, and methyl ethyl ketone as an organic solvent was removed from the resulting mixture under a partially reduced pressure of 100 mmHg while the reactor was heated to 90° C. and collected using a condenser. After 4 hours, the amount of obtained methyl ethyl ketone was measured to check that the methyl ethyl ketone had been completely removed, and then the reactor was cooled down to 60° C.

Then, the reactor was cooled to 25° C., and the toner was separated from the resultant by using a filter that is commonly used in the art. The toner was washed with 1 N hydrochloric acid solution, and then washed 5 times with distilled water to completely remove a surfactant, and the like. Then, the washed toner particles were dried in a fluidized bed dryer at 40° C. for 5 hours to obtain dried toner particles.

As a result of analyzing the toner particles, it was found that the obtained toner particles had a volume average particle size of 6.7 μm, an 80% span value of 0.55 and circularity of 0.982.

### Example 2

Toner particles were prepared in the same manner as in Example 1 except that the magenta pigment master batch prepared according to Preparation Example 7 was used instead of the cyan pigment master batch 1 prepared according to Preparation Example 6.

As a result of analyzing the toner particles, it was found that the obtained toner particles had a volume average particle size of 6.8 μm, an 80% span value of 0.59 and circularity of 0.980.

### Example 3

Toner particles were prepared in the same manner as in Example 1 except that the yellow pigment master batch prepared according to Preparation Example 8 was used instead of the cyan pigment master batch 1 prepared according to Preparation Example 6.

As a result of analyzing the toner particles, it was found that the obtained toner particles had a volume average particle size of 6.6 μm, an 80% span value of 0.61 and circularity of 0.978.

### Example 4

Toner particles were prepared in the same manner as in Example 1 except that the black pigment master batch prepared according to Preparation Example 9 was used instead of the cyan pigment master batch 1 prepared according to Preparation Example 6.

As a result of analyzing the toner particles, it was found that the obtained toner particles had a volume average particle size of 6.7 μm, an 80% span value of 0.56 and circularity of 0.982.

### Example 5

Toner particles were prepared in the same manner as in Example 1 except that the polyester resin 2 prepared according to Preparation Example 2 was used instead of the polyester resin 1 including higher fatty acid residue prepared according to Preparation Example 1, and the cyan pigment master batch 2 prepared according to Preparation Example 10 was used instead of the cyan pigment master batch 1 prepared according to Preparation Example 6.

As a result of analyzing the toner particles, it was found that the obtained toner particles had a volume average particle size of 6.7 μm, an 80% span value of 0.59 and circularity of 0.989.

### Example 6

Toner particles were prepared in the same manner as in Example 1 except that the polyester resin 3 including higher alcohol residue prepared according to Preparation Example 3 was used instead of the polyester resin 1 including higher fatty acid residue prepared according to Preparation Example 1, and the cyan pigment master batch 3 prepared according to Preparation Example 11 was used instead of the cyan pigment master batch 1 prepared according to Preparation Example 6.

As a result of analyzing the toner particles, it was found that the obtained toner particles had a volume average particle size of 6.5 μm, an 80% span value of 0.61 and circularity of 0.979.

### Example 7

Toner particles were prepared in the same manner as in Example 1 except that the polyester resin 4 including higher fatty acid and higher alcohol residues prepared according to Preparation Example 4 was used instead of the polyester resin 1 including higher fatty acid residue prepared according to Preparation Example 1, and the cyan pigment master batch 4 prepared according to Preparation Example 12 was used instead of the cyan pigment master batch 1 prepared according to Preparation Example 6.

As a result of analyzing the toner particles, it was found that the obtained toner particles had a volume average particle size of 6.5 μm, an 80% span value of 0.62 and circularity of 0.975.

### Comparative Example 1

Toner particles were prepared in the same manner as in Example 1 except that the polyester resin 5 which does not include higher fatty acid and higher alcohol residues and prepared according to Preparation Example 5 was used instead of the polyester resin 1 including higher fatty acid residue prepared according to Preparation Example 1, the cyan pigment master batch 4 prepared according to Preparation Example 12 was used instead of the cyan pigment master batch 1 prepared according to Preparation Example 6, and 5 g of carnauba wax (SX-70; manufactured by Max Chemical, Daejeon, Korea) was added thereto after adding a charge control agent.

As a result of analyzing the toner particles, it was found that the obtained toner particles had a volume average particle size of 6.5 μm, an 80% span value of 0.62 and circularity of 0.988.

### Comparative Example 2

Toner particles were prepared in the same manner as in Comparative Example 1, except that the carnauba wax was not used.

As a result of analyzing the toner particles, it was found that the obtained toner particles had a volume average particle size of 6.4 μm, an 80% span value of 0.61 and circularity of 0.981.

The Tg and acid value of the polyester resins prepared according to Preparation Examples 1 to 5 were measured using the following method.

Using a differential scanning calorimeter (DSC, manufactured by Netzsch Co.), a sample was heated from 20 to 200° C. at 10° C./min, rapidly cooled to 10° C. at 20° C./min, and heated at 10° C./min to measure a glass transition temperature (Tg).

The polyester resins were dissolved in dichloro methane and cooled, and then the mixture was titrated with a 0.1N KOH methyl alcohol solution to measure the acid value (mgKOH/g).

### Evaluation Example

Physical properties of the toner particles prepared according to Examples 1 to 7 and Comparative Examples 1 and 2 were evaluated, and the results are shown in Table 1 below.

Volume average particle sizes of the toner according to Examples 1 to 7 and Comparative Examples 1 and 2 were measured using a Coulter Multisizer 3. Aperture of 100 gm was used in the Coulter Multisizer 3, an appropriate amount of a surfactant was added to 50 to 100 ml of ISOTON-II (Beckman Coulter Co.) as an electrolyte, and 10 to 15 mg of a sample to be measured was added thereto, and the resultant was dispersed in a ultrasonic dispersing apparatus for 1 minute to prepare a sample for the Coulter Multisizer.

In addition, the 80% span value, indicating the particle size distribution, was calculated using Equation 1 below. The volume of toner particles is accumulated from particles of the smallest size in ascending order until the accumulated volume reaches 10% of the total volume of the toner. An average particle size of the accumulated particles corresponding to 10% of the total volume of the toner is defined as d10. Average particle sizes of the accumulated particles corresponding to 50% and 90% of the total volume of the toner are respectively defined as d50 and d90.

80% span value=(d90−d10)/d50 Equation 1

Here, a smaller span value indicates a narrower particle size distribution, and a larger span value indicates a wider particle size distribution.

Circularity was measured by using an FPIA-3000 (manufactured by Sysmex, in Japan). While measuring the circularity by using the FPIA-3000, samples were manufactured by adding a suitable amount of surfactant to 50˜100 ml of distilled water, adding 10˜20 mg of toner particles thereto, and then dispersing the resultant in an ultrasonic disperser for 1 min.

The circularity was automatically obtained by the FPIA-3000 according to Equation 2 below.

Circularity=2×(area×π)^{1/2}/perimeter Equation 2

Here, the area indicates a projected area of the toner and the perimeter indicates a projected circumference of the toner. A value of the circularity may be in the range of 0 to 1, wherein the closer the value is to 1, the more circular the toner is.

### Fixing Temperature Range

9.75 g of toner particles prepared in any of Examples 1 through 7 and Comparative Examples 1 and 2, 0.2 g of silica (TG 810G; Cabot Co.) and 0.05 g of silica (RX50, Degussa GmbH) were mixed to prepare a toner composition with external additives. Using the toner with external additives, unfixed solid images of 30 mm×40 mm were formed using a Samsung CLP-510 printer. Then, the fixing properties of the unfixed images were evaluated while varying the temperature of a fixing roller of a fixing tester in which the fixing temperature could be controlled. The fixing properties were evaluated using the following method. That is, 3M tape was adhered to fixed images from the fixing tester at a pressure of 50 g/cm², and the tape was slowly detached. Image densities (ID) of the fixed images measured before the tape was attached onto the fixed images and after the tape was detached from the fixed images were measured. When a percentage obtained by dividing the image density of the fixed images measured after the tape was detached from the fixed images by the image density of the fixed images measured before the tape was attached onto the fixed images is greater than 80%, the temperature of the fixing roller was included within the fixing temperature range.

The image density was measured using a SpectroEye (Gretagmacbeth), which is a Macbeth reflection spectrodensitometer.

The results of the evaluation are shown in Table 1 below.

TABLE 1

| | Volume average | | | Fixing |
|---|---|---|---|---|
| | particle size | 80% span | | temperature |
| | (μm) | value | Circularity | range (° C.) |
| Example 1 | 6.7 | 0.55 | 0.982 | 140 to 190 |
| Example 2 | 6.8 | 0.59 | 0.980 | 140 to 190 |
| Example 3 | 6.6 | 0.61 | 0.978 | 140 to 190 |
| Example 4 | 6.7 | 0.56 | 0.982 | 140 to 190 |
| Example 5 | 6.7 | 0.59 | 0.989 | 130 to 190 |
| Example 6 | 6.5 | 0.61 | 0.979 | 140 to 190 |
| Example 7 | 6.5 | 0.62 | 0.975 | 140 to 190 |
| Comparative | 6.5 | 0.62 | 0.988 | 130 to 190 |
| Example 1 | | | | |
| Comparative | 6.4 | 0.61 | 0.981 | 170 to 180 |
| Example 2 | | | | |

Referring to Table 1, even though wax was not added, the toner according to embodiments of the present invention (Examples 1 to 7) prepared using the polyester resin into which higher fatty acid and/or higher alcohol residues are introduced showed a similar fixing temperature range when compared with the toner prepared by adding wax to the polyester resin (Comparative Example 1) and a far wider fixing temperature range when compared with the toner without using wax (Comparative Example 2). The volume average particle size, 80% span value, and circularity of the toner according to Examples 1 to 7 were similar to those of the toner according to Comparative Examples 1 to 2.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A toner comprising:
a binder resin into which at least one component selected from the group consisting of a C8-C60 higher fatty acid residue and a C8-C60 higher alcohol residue is introduced by esterification;
a colorant; and
at least one additive.

2. The toner of claim 1, wherein the binder resin is prepared by introducing at least one residue selected from the group consisting of the higher fatty acid residue and the higher alcohol residue into a polyester resin by esterification.

3. The toner of claim 2, wherein the polyester resin is prepared by the polycondensation of an acid component and a diol component.

4. The toner of claim 1, wherein the total content of the higher fatty acid residue and the higher alcohol residue is in the range of 1 to 50% by weight based on the total weight of the binder resin into which at least one residue selected from the group consisting of the higher fatty acid residue and the higher alcohol residue is introduced.

5. The toner of claim 1, wherein the colorant is in the form of a pigment master batch.

6. The toner of claim 5, wherein the pigment master batch comprises a resin into which at least one residue selected from the group consisting of a C8-C60 higher fatty acid residue and a C8-C60 higher alcohol residue is introduced by esterification, and a pigment dispersed in the resin.

7. A method of preparing a toner, the method comprising the steps of:
preparing a dispersion medium;
preparing a toner suspension by adding a binder resin into which at least one residue selected from the group consisting of a C8-C60 higher fatty acid residue and a C8-C60 higher alcohol residue is introduced by esterification, a colorant, and at least one additive to the dispersion medium; and
preparing a toner mixture by removing an organic solvent from the toner suspension.

8. The method of claim 7, wherein the colorant is in the form of a pigment master batch.

9. The method of claim 8, wherein the pigment master batch comprises a resin into which at least one residue selected from the group consisting of a C8-C60 higher fatty acid residue and a C8-C60 higher alcohol residue is introduced by esterification, and a pigment dispersed in the resin.
